(19) United States
(12) Patent Application Publication
(10) Pub. No.: US 2016/0364766 A1
(43) Pub. Date: Dec. 15, 2016

(54) ALLOCATION OF CONTENT INVENTORY UNITS

(71) Applicant: Google Inc., Mountain View, CA (US)

(72) Inventors: Yishay Mansour, Tel Aviv (IL); Martin Pal, Mountain View, CA (US); Gagan Goel, Mountain View, CA (US); David Pal, Mountain View, CA (US)

(73) Assignee: Google Inc., Mountain View, CA (US)

(21) Appl. No.: 13/974,387

(22) Filed: Aug. 23, 2013

Related U.S. Application Data
(60) Provisional application No. 61/837,307, filed on Jun. 20, 2013.

(51) Int. Cl. G06Q 30/02

(52) U.S. Cl. CPC G06Q 30/0275

(57) ABSTRACT

Example systems may include: receiving a request for allocation of a content inventory unit; receiving two or more bids for the content inventory unit, each bid being subject to a respective sharing fraction; determining one or more adjusted bids, where each adjusted bid is determined based on one of the two or more bids and the respective sharing fraction for the bid; allocating the content inventory unit to a buyer that submitted a highest bid from among the two or more bids; determining a payment from the buyer as a maximum member of a first set of prices that comprises at least one of the two or more bids; determining a payment to a seller as a maximum member of a second set of prices that includes at least one of the adjusted bids; and transmitting data reflecting the allocation of the content inventory unit to the buyer.

### CROSS-REFERENCE TO RELATED APPLICATION

Priority is hereby claimed to U.S. Provisional Application No. 61/837,307, which was filed on Jun. 20, 2013. The contents of U.S. Provisional Application No. 61/837,307 are hereby incorporated by reference into this disclosure as if set forth herein in full.

### BACKGROUND

This disclosure relates to the selection and delivery of online content. Online content can include web pages and advertisements displayed with the web pages. Content publishers have space that they sell to advertisers or other content providers directly or through intermediaries, such as brokers. Some of a publisher's available space may be sold through a content inventory marketplace. This content inventory market is a spot market that connects publishers with content providers (e.g., advertisers) in response to a request for content from a user. The publisher may communicate with one or more content providers or market intermediaries in an attempt to sell the space in time to serve content associated with the buyer.

Some auctions have a property called truthfulness. A truthful auction creates incentives for each bidder to reveal their private information by bidding their true valuation for the thing that is being auctioned. In other words, for each bidder, making a bid equal to their true valuation is the dominant strategy to maximize their individual utility. For example, some second-price auctions have the truthfulness property.

### SUMMARY

Example systems for allocating content inventory units may include the following: receiving a request for allocation of a content inventory unit; receiving two or more bids for the content inventory unit, where each bid is subject to a respective sharing fraction; determining one or more adjusted bids, where each adjusted bid is determined based on one of the two or more bids and the respective sharing fraction for the bid; allocating the content inventory unit to a buyer that submitted a highest bid from among the two or more bids; determining a payment from the buyer as a maximum member of a first set of prices that includes at least one of the two or more bids; determining a payment to a seller as a maximum member of a second set of prices that includes at least one of the adjusted bids; and transmitting data reflecting the allocation of the content inventory unit to the buyer. The example systems may include one or more of the following features, either alone or in combination.

The second set of prices may include a first price. The example systems may include receiving the first price for the content inventory unit, where the first price is a minimum payment that the seller will accept for allocation of the content inventory unit.

The example systems may include: transmitting an auction announcement message to a potential buyer, where the auction announcement message includes a minimum bid requirement for the auction; and determining the minimum bid requirement to be equal to the first price divided by one minus a sharing fraction for bids from the potential buyer.

The example systems may include: comparing each adjusted bid to the first price; and for any adjusted bid less than the first price, excluding a corresponding bid from the first set of prices, where the adjusted bid was determined based on the corresponding bid.

The first set of prices may include a shadow bid. The example systems may include: receiving a first price for the content inventory unit, where the first price is a minimum payment that the seller will accept for allocation of the content inventory unit; and determining the shadow bid based on the first price, where the shadow bid is set equal to the first price divided by one minus a minimum sharing fraction for an auction platform.

The first set of prices may include all of the two or more bids except the highest bid from among the two or more bids. The second set of prices may include all of the adjusted bids except a highest adjusted bid from among the adjusted bids.

Determining each adjusted bid may include multiplying one of the two or more bids by one minus the respective sharing fraction for the bid.

The content inventory unit may be allocated to the buyer based on the results of a truthful auction.

Particular embodiments of the subject matter described in this disclosure can be implemented to realize none, one or more of the following advantages. Content inventory units may be allocated to a buyer with the highest expressed valuation of the content inventory unit. Publishers selling content inventory units through an auction platform and bidders purchasing content inventory units through the auction platform may all be satisfied with performance of the auction mechanism despite the presence of different sharing fractions for different bidders. Revenue realized by an online content inventory unit auction platform may be increased.

Two or more of the features described in this disclosure/specification, including this summary section, can be combined to form implementations not specifically described herein.

The systems and techniques described herein, or portions thereof, can be implemented as a computer program product that includes instructions that are stored on one or more non-transitory machine-readable storage media, and that are executable on one or more processing devices. The systems and techniques described herein, or portions thereof, can be implemented as an apparatus, method, or electronic system that can include one or more processing devices and memory to store executable instructions to implement the stated operations.

The details of one or more implementations are set forth in the accompanying drawings and the description below. Other features, objects, and advantages will be apparent from the description and drawings, and from the claims.

### BRIEF DESCRIPTION OF THE DRAWINGS

FIG. 1 is a block diagram of an example online environment.

FIG. 2 is block diagram of an example spot market for content inventory.

FIG. 3 is a flowchart of an example process for allocating a content inventory unit to a buyer in response to a user request for content.

FIG. 4 is block diagram of an example computer system that can be used to facilitate the selection and delivery of content.

### DETAILED DESCRIPTION

A content item is any data that can be provided over a network. For example, an advertisement, including a link to a landing page is a content item. The processes described below are illustratively applied to content items that are advertisements provided in response to a request from an online resource, but the processes are also applicable to other content items provided over a network.

A content inventory unit is a unit of content space inventory (e.g., a space for an advertisement paired with an online resource). For example, a content inventory unit may occur when an advertisement is delivered, usually with an accompanying online resource, to a user. A content inventory unit may have a number of characteristics, such as characteristics of the requested resource to be paired with the secondary content (e.g., an advertisement or other content item), parameters (e.g., dimensions or format) of a content slot in which the secondary content will be presented, the timing of the user request and corresponding delivery of content, and characteristics of the user who requested the content, such as demographic information and geographic location. A single user request for content may initiate multiple content inventory units. For example, a user request for a web page may allow a publisher to deliver multiple advertisements that are displayed in different locations within the rendered web page. In some implementations, a system can record an indication of each delivered content inventory unit, such as for accounting purposes.

Online content publishers try to derive as much revenue as they can from their available inventory (e.g., content inventory units in which advertisements or other content items may be presented). Publishers sell some of their inventory in guaranteed deals to individual content providers. The rest they generally provide to a number of different Market-Based Buyers (“MBBs”), who in turn sell to the highest bidder and pay the publisher some proportion of the received price. For example, MBBs can be yield managers or exchanges.

One type of MBB is an auction platform. An auction platform can allocate a content inventory unit by accepting bids from one or more potential buyers (e.g., advertisers, advertising networks, or other demand-side platforms), selecting a winning bid, and determining a buyer's price for the content inventory unit based on a set of rules called an auction mechanism. In some implementations, the auction mechanism may be designed to be truthful, in the sense that it incentivizes potential buyers to bid their true valuation of the content inventory unit. For example, a second-price auction may create an incentive for a potential buyer to bid their true valuation of a content inventory unit. When a content inventory unit is allocated to a winner of one of these auctions, the winning buyer pays a price determined by the auction mechanism and this revenue may be shared by the publisher, an operator of the auction platform.

A sharing fraction is a value less than one that may be used to determine a portion of the revenue from a content inventory unit allocation that will be paid to an entity participating in the allocation of the content inventory unit (e.g., a publisher of the content slot in which the content inventory unit occurs, an operator of the auction platform, or an operator of an advertisement network that facilitates the allocation). For example, a maximum commission (e.g., 10% or 20%) that a bidder agrees to pay to an auction platform is a sharing fraction.

A reserve price may be declared by a seller (e.g., a publisher) when submitting a request for allocation of a content inventory unit through an auction platform. The reserve price declared by the seller may be the minimum amount of revenue that the seller will accept in return for the allocation of the content inventory unit. If no bid exceeds the reserve price, then the content inventory unit may not be allocated through the auction platform (or equivalently, the content inventory unit is allocated back to the seller). In this case, the auction platform may receive zero revenue.

When running an auction for a content inventory unit, the auction mechanism may adjust the bids received based on a sharing fraction specifying a portion of the revenues that may be retained by the auction platform. The adjusted bids may be compared to the seller's declared reserve price to ensure that any allocation to a buyer results in sufficient revenue to make a payment of at least the seller's declared reserve price and also pay the operator of the auction platform the revenues determined by its sharing fraction.

Where different potential buyers or bids are each subject to different sharing fractions, it is possible that the highest received bid does not correspond to the highest adjusted bid. In this case, applying an auction mechanism (e.g., a second-price auction) to the adjusted bids can result in a different allocation of the content inventory unit than applying the same auction mechanism to the received unadjusted bids. From the perspective of a publisher selling a content inventory unit through the auction platform, it is better to apply the auction mechanism to the adjusted bids, because that generally results in more revenue for the publisher. From the perspective of a potential buyer bidding for a content inventory unit through the auction platform, it is better to apply the auction mechanism to the received unadjusted bids, because that will allocate the content inventory unit to the buyer that values content inventory unit most (e.g., the buyer that is willing to pay the most). Thus there is a tension between the interests of the seller and the potential buyers with regard to the operation of the auction mechanism.

In some implementations, an auction platform seeks to satisfy both sellers and buyers by allocating a content inventory unit based on received unadjusted bids to the highest bidder, while determining the price paid to the seller based on the set of adjusted bids. By satisfying both sets of users of the auction platform, the auction platform may receive more content inventory allocation requests and bids and ultimately generate more revenue for the auction platform. In some cases, the revenue retained by the auction platform for allocation of a particular content inventory unit may also be increased. In some implementations, a content inventory unit is allocated to a buyer that submitted the highest valid unadjusted bid and the price paid by this buyer is determined based on a set of received unadjusted bids. For example a second-price auction mechanism may be applied to the set of valid received unadjusted bids to allocate the content inventory unit and determine the buyer's price. The price paid to the seller (e.g., the publisher) of the content inventory unit may be determined as a maximum of its declared reserve price and the second highest adjusted bid, which may or may not correspond to the second highest unadjusted bid. The auction platform may retain as revenues the difference between the price paid by the winning bidder and the price paid to the seller. In some implementations, the content inventory unit is allocated and prices are determined in a manner that preserves a truthful property of an auction mechanism.

Consider the following illustrative example. A publisher submits a content inventory unit allocation request to an auction platform seeking to sell a content slot in a webpage the publisher is serving to a user to an advertiser or other content item provider that wants to present a content item (e.g., an advertisement) to the user. The request specifies a reserve price of $0.50 for the content inventory unit. The auction platform solicits and receives two bids for the content inventory unit. The first bidder, Advertiser A, submits a bid of $1.00 that is subject to a 20% maximum commission. The adjusted bid for Advertiser A is determined as $1.00*(1−0.2)=$0.80. The second bidder, Advertiser B, submits a bid of $0.90 that is subject to a 10% maximum commission. The adjusted bid for Advertiser B is determined as $0.90*(1−0.1)=$0.81. Consider three alternative auction mechanisms and the resulting allocations with payments:

(1) A second-price auction applied to the adjusted bids—Advertiser B wins and the publisher is paid $0.80 (the maximum of the reserve price and the second highest adjusted bid), while Advertiser B pays $0.88=$0.80/(1−0.1) and the auction platform retains $0.08 as revenue.

(2) A second price auction applied to the received unadjusted bids—Advertiser A wins and pays $0.90. The publisher is paid $0.72=$0.90*(1−0.2) and the auction platform retains $0.18 as revenue.

(3) A hybrid auction mechanism determining the winning bidder and their price based on the received unadjusted bids and determining the publisher's price based on the adjusted bids—Advertiser A wins and pays $0.90 (the second highest unadjusted bid). The publisher is paid $0.80 (the maximum of the reserve price and the second highest adjusted bid). The auction platform retains $0.10 as revenue.

The winner of the auction is allocated the content inventory unit and the winner's advertisement is presented to a user through a display on the user device in the content slot within the requested webpage. In this scenario, when the third auction mechanism is employed, the content inventory unit is allocated to the highest bidder who presumably values the content inventory the most, the publisher gets revenue as high or higher than when the other two auction mechanisms are used, and the auction platform gets more revenue than when the first auction mechanism is used.

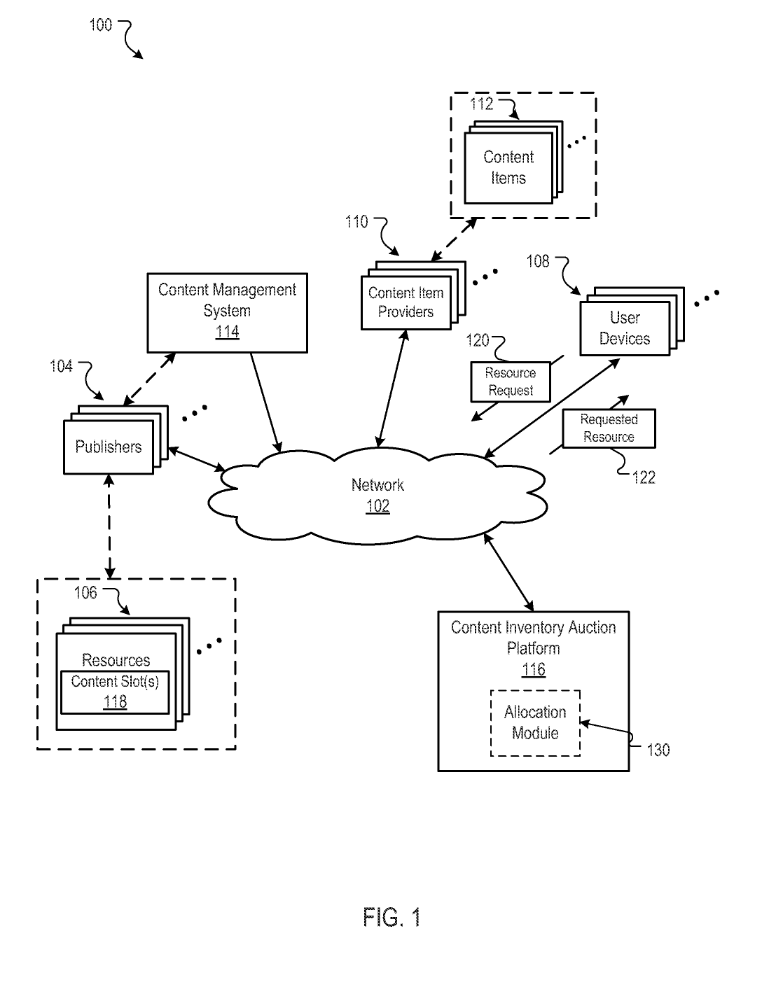

FIG. 1 is an illustration of an example environment 100 in which content is provided to a user. The example environment 100 includes a network 102, such as a local area network (LAN), a wide area network (WAN), the Internet, or a combination thereof. The example environment 100 also includes publishers 104 that host (directly or indirectly) resources 106, user devices 108, content item providers 110 that host (directly or indirectly) content items 112, a content management system 114, and a content inventory auction platform 116. While the content management system 114 and content inventory auction platform 116 are depicted separately, they may be realized as part of a single system.

A resource 106 is data provided over the network 102. A resource 106 is identified by a resource address that is associated with the resource 106. Resources 106 include HTML pages, word processing documents, portable document format (PDF) documents, images, video, and feed sources, to name only a few. The resources 106 can include content, such as words, phrases, images and sounds, that may include embedded information (such as meta-information in hyperlinks) and/or embedded instructions (such as scripts). Resources 106 may also include one or more content slots 118, which are portions of a resource 106 in which advertisements or other content items 112 are inserted for presentation to a user. Resources are generally hosted by publishers 104 either directly (e.g., on a server computer owned by the publisher) or indirectly (e.g., on a server computer owned by a third party but paid for by the publisher). A publisher 104 is an entity that hosts and/or provides electronic access to a resource (e.g., web page content) by use of the network 102. Publishers 104 may generate revenue by selling content item space (e.g., content slots 118) to content item providers 110.

Content item providers 110 are entities, such as advertisers (and may also be publishers), that provide content items 112, such as advertisements, for display with resources 106. The content items 112 may be any type of data, and can include, for example, informational, education, or entertainment content, as well as advertisements in the form of graphical advertisements, such as banner advertisements, text only advertisements, image advertisements, audio advertisements, video advertisements, advertisement gadgets with or without interactive features, advertisements combining one of more of any of such components, etc., or any other type of electronic advertisement or content item document. The content items 112 may also include embedded information, such as a links, meta-information, and/or machine executable instructions, such as HTML or JavaScript™. While reference is made herein to the delivery of ads, other forms of content items including other forms of sponsored content items can be delivered by the systems and methods proposed.

A user device 108 is an electronic device that is under control of a user and is capable of requesting and receiving resources 106 over the network 102. Example user devices 108 include a web-enabled handheld device, a mobile telephone or smartphone, tablet device, a set top box, a game console, a personal digital assistant, a navigation device, a computer, and other devices that can send and receive data over the network 102. A user device 108 typically includes a user application, such as a web browser, to facilitate the sending and receiving of data over the network 102.

The content management system 114 may include one or more data processing apparatus, is capable of communicating across the network 102, and may be coupled to a data store. The system 114 provides content items for display with resources 106. The system 114 may be in direct or indirect communication with publishers 104 and content item providers 110 to manage publishers' content inventory and content item providers' demands.

The content management system 114 may also be coupled to a content inventory auction platform 116 that conducts auctions for content inventory units occurring in available content slots 118. Content item providers 110 may be permitted to select, or bid, an amount the content item providers 110 are willing to pay for each content inventory unit, e.g., a cost-per-mille amount an advertiser pays for presentation of an advertisement (a cost per-thousand content inventory units) or an amount that the content item provider pays when, for example, a user clicks on an advertisement (a cost-per-click). The cost-per-click can include a maximum cost-per-click, e.g., the maximum amount an advertiser is willing to pay for each click of an advertisement based on a keyword that is used to select the advertisement. For example, advertisers A, B, and C all select, or bid, a maximum cost-per-click of $.50, $.75, and $1.00, respectively. The content inventory auction platform 116 can select the advertisement provided by the highest bidding advertiser and provide that advertisement for display in the content slot 118 of the auctioned content inventory unit.

When a user device 108 submits a resource request 120 to a publisher 104, the publisher 104 causes the requested resource 122 to be provided to the user device 108 in response to the request 120. The requested resource 122 content can include executable instructions that can be executed at the user device 108 to request content items from the content management system 114. When the content management system 112 receives a request for a content item, it may (i) provide a content item from a content item provider 110 who has an agreement with the publisher 104 to provide a content item for the requested resource 122, (ii) provide a content item obtained from the content inventory auction platform 116, or (iii) provide no content item. In some implementations, the content management system 114 chooses the option that is designed to provide the most revenue for the publisher, while also fulfilling all content item reservations.

Content inventory auction platform 116 may include an allocation module 130 that responds to requests for allocation of content inventory units by allocating a content inventory unit to a content item chosen using an auction mechanism applied to received bids for a content inventory unit. The allocation module 130 may receive multiple bids that are subject to different sharing fractions (e.g., different commissions). In some implementations, the allocation module 130 determines adjusted bids based on the received bids and their respective sharing fractions. The allocation module 130 may allocate the content inventory unit to content item associated with the highest valid received bid. The amount to be paid by the buyer who placed the winning bid may be determined based on the received bids (e.g., equal to the second highest received bid), while the amount to be paid to the seller of the content inventory unit may be determined based on the adjusted bids (e.g., equal to the second highest adjusted bid).

Data reflecting the allocation of the content inventory unit and the required payments may be transmitted via one or more network interfaces of the content inventory auction platform 116. For example, data identifying the content item associated with the winning bid may be transmitted through network 102 to content management system 114 in response to a request for allocation of the content inventory unit. In some implementations, data identifying the content item associated with the winning bid may be transmitted through network 102 to a user device 108 that submitted resource request 120 or to a publisher 104 that will respond to the resource request 120 by transmitting the requested resource 122. In some implementations, data reflecting the required payment from the winning bidder may be transmitted to a content item provider 110 that submitted the winning bid and data reflecting the required payment to the seller may be transmitted to a publisher 104 and/or a content management system that sold the content inventory unit.

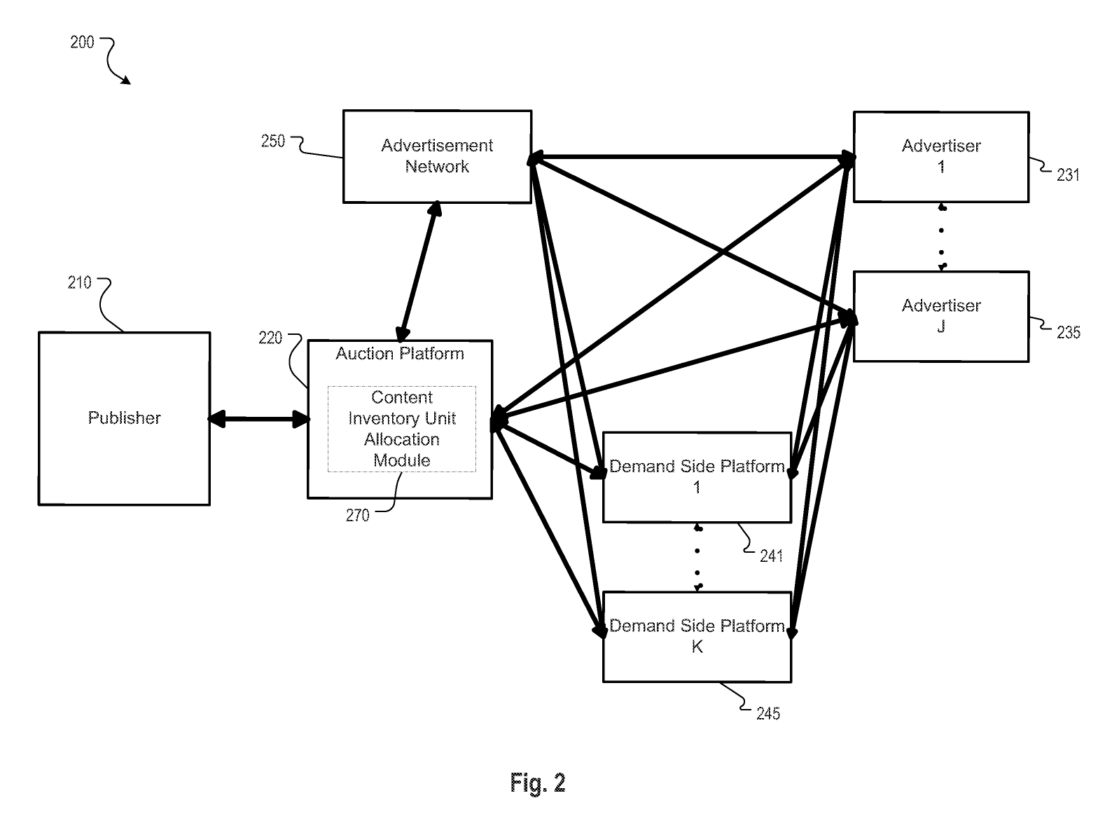

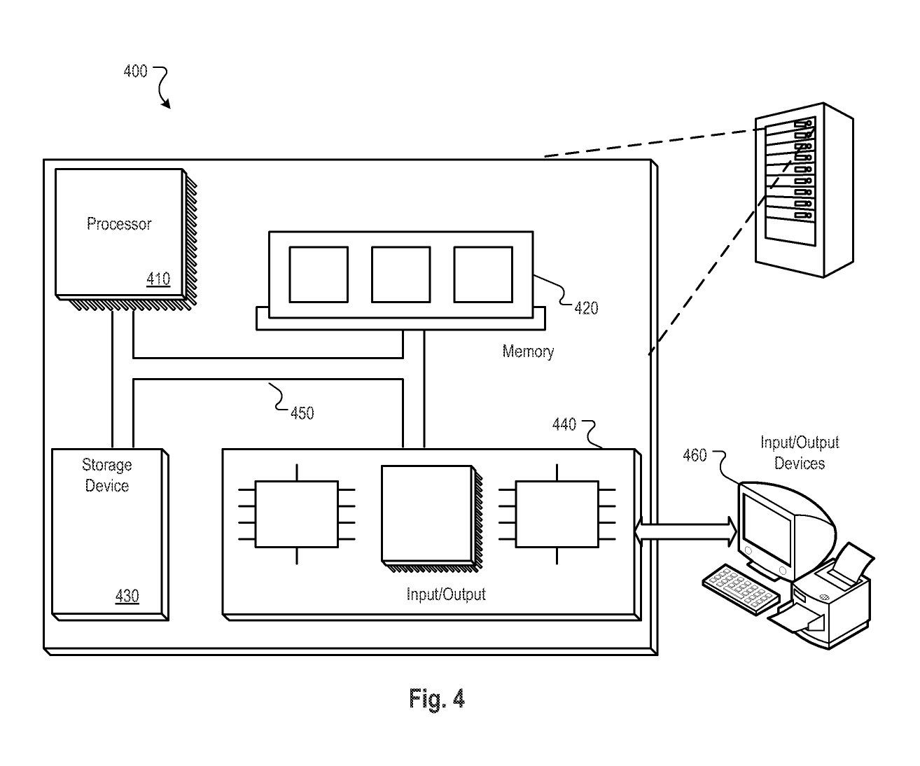

The allocation module 130 may be implemented in a variety of hardware and software configurations. For example, it may be implemented in software running on a dedicated processing system that is connected to a network, such as the Internet. The allocation module 130 may also be implemented in software that runs on a processing system utilized for other functionality, such as content management system 114 or a publisher's webserver. In some implementations an allocation module 130 may run on a single processing device, such as the processing described below with reference to FIG. 4. In some implementations, an allocation module 130 may run on multiple processing devices that communicate over a network and form a distributed computing system. FIG. 2 is a block diagram of an example spot market for content inventory. The figure depicts the relationships between participants in the market. The lines in the figure represent transactions in which content inventory units are exchanged for content items and revenue. Typically a content inventory unit, or information describing a content inventory unit, flows from left to right across the market via one or more transactions. In return a content item (e.g., an ad), or information concerning a content item, that will be served in the content inventory unit and revenue flow back to the publisher via the same transaction pathway. Some portion of the revenues flowing from right to left may be retained by intermediaries in the spot market (e.g., auction platform 220) that facilitate the allocation of a content inventory unit to a buyer with a content item it wishes to present to a user.

A publisher 210 sells content inventory units to buyers. Usually, the publisher 210 allocates a content inventory unit through an MBB, such as auction platform 220. The MBB in turn sells the content inventory unit to a content provider (e.g., Advertiser 231 or 235) either directly or through another intermediary, such as a Demand-Side Platform (“DSP”) (e.g., DSP 241 or DSP 245). Content networks (e.g., advertisement network 250) may act as DSPs in some implementations. An MBB can conduct an auction for the content inventory unit, selling the content inventory unit to, for example, the highest bidder. The auction platform 220, for example, then provides a portion of the revenues from the sale to the publisher 210. The advertiser 231, for example, that ultimately buys the content inventory unit, gets to have one of its ads served or delivered to the user in the content inventory unit.

The auction platform 220 may use a content inventory unit allocation module 270 to implement an auction mechanism and allocate the content inventory unit in a systematic and efficient manner. For example, the content inventory unit allocation module 270 may solicit and receive bids from multiple advertisers (e.g., advertiser 231) and/or demand side platforms (e.g., demand side platform 241). The auction platform 220 may apply different sharing fractions to various bids that it receives. For example, the content inventory allocation module 270 may determine an adjusted bid for a potential buyer by multiplying a bid received from the potential buyer by one minus a sharing fraction (e.g., a commission) associated with the potential buyer and/or the particular bid. In some implementations, where the publisher 210 has specified a reserve price for the auction of the content inventory unit, the adjusted bid for a potential buyer may be compared to the reserve price. If the adjusted bid for potential buyer is less than the reserve price, the corresponding bid received from that potential buyer may be disqualified or designated as invalid so that the content inventory unit will not be allocated that potential buyer.

A set of valid received bids may be compared by the content inventory allocation module 270 to select a winning bid (e.g., the highest valid received bid). The content inventory unit may be allocated to a content item associated with the winning bid (e.g., an advertisement provided by advertiser 231 that submitted the highest bid). In some implementations, the set of valid received bids are processed by the content inventory allocation module 270 to determine a price to be paid by the winning bidder for the content inventory unit. For example, the price to be paid by the winning bidder may be determined as the second highest received bid. In some implementations, the amount paid to the publisher 210 for the content inventory unit is determined based on a set of adjusted bids. For example, the price paid to the publisher 210 may be determined as the second highest adjusted bid. The difference between the price paid by the winning bidder and the price paid to the publisher 210 may be retained by the auction platform 220 as revenue.

In systems where different buyers are subject to different sharing fractions, allocating the content inventory to a bidder with the highest receive unadjusted bid may increase buyer utility compared to auction mechanism that allocates the content inventory unit based on adjusted bids. Determining the buyer's price for the content inventory unit based on the received unadjusted bids while determining the seller's price based on the adjusted bids may respect the viewpoints of both the buyer and the seller and increase the satisfaction of users of the auction platform 220. Revenues retained by the auction platform 220 may be increased compared to auction platforms implementing alternative auction mechanisms.

The content inventory unit allocation module 270 may record data regarding the transaction for accounting purposes or for use in updating distributions of bids and/or reserve prices. The information saved may include the reserve price received from the seller, the bids received, an identification of the buyer, and/or information about the content inventory unit, such as an identification of the content slot and the publisher, the time, or user characteristics. This transaction data may be stored directly in a record associated with a particular publisher or content slot. In some implementations, the information may be stored in a log of transactions that is processed periodically to update system parameters, such as distributions of bids and/or reserve prices.

For situations in which the systems discussed here collect personal information about users, or may make use of personal information, the users may be provided with an opportunity to control whether programs or features collect personal information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

The content inventory unit allocation module 270 may be implemented in a variety of hardware and software configurations. For example, it may be implemented in software running on a dedicated processing system that is connected to a network, such as the Internet. The content inventory unit allocation module 270 may also be implemented in software that runs on a processing system utilized for other functionality, such as a content management system 114. In some implementations a content inventory unit allocation module 270 may run on a single processing device, such as the processing described below with reference to FIG. 4. In some implementations, a content inventory unit allocation module 270 may run on a on a multiple processing devices that communicate over a network and form a distributed computing system.

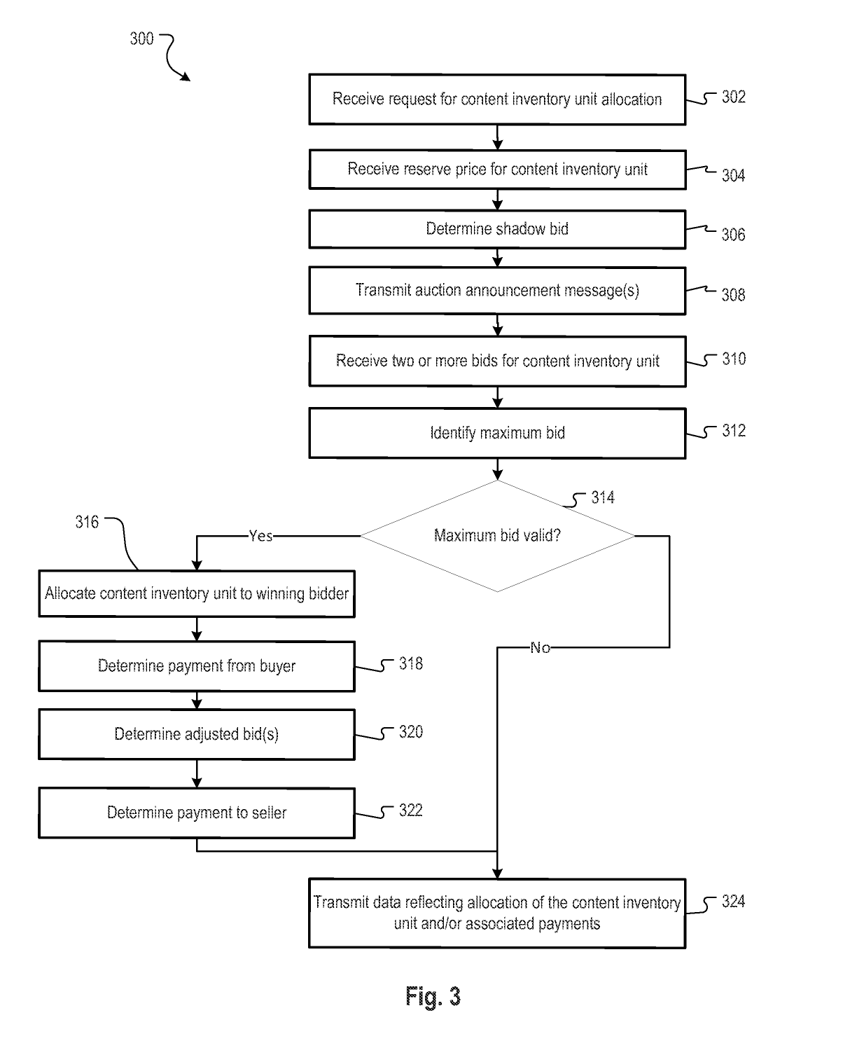

FIG. 3 is a flow chart of an example process 300 for allocating a content inventory unit to a buyer in response to a request. The content inventory unit allocation process 300 may be performed by the allocation module 130 or the content inventory unit allocation module 270. Operations commence when the auction platform receives 302 a request for a content inventory unit to be allocated. For example, the request for content inventory unit allocation may be received from a publisher. In other examples, the request may be received from an advertisement management system, or directly from a user device requesting content including the content inventory unit, among other possible sources. The process 300 may be performed for each content inventory unit implicated by a user request for content. For example, the request may be received 302 through a network interface of content inventory auction platform 116 or auction platform 220.

A reserve price is received 304 as part of the request or in a related communication. The reserve price may correspond to a minimum amount of revenue that will be accepted in exchange for the content inventory unit. In some implementations, the reserve price is declared by the publisher of the content in which the content slot of the content inventory unit occurs. The reserve price may be received from the publisher's server system or from another device associated with the request for allocation of the content inventory unit. For example, the reserve price may be received 304 through a network interface of content inventory auction platform 116 or auction platform 220.

A shadow bid may be determined 306 based on the received reserve price and a minimum sharing fraction for an auction platform. For example, the shadow bid may be calculated as:

s=r/(1−λₘᵢₙ)

where s is the shadow bid, r is the received reserve price, and λₘᵢₙ is the minimum sharing fraction for the auction platform. The shadow bid may be used as a proxy for the reserve price that is compared to received unadjusted bids to ensure that the seller receives at least its reserve price and the auction platform retains at least its minimum sharing fraction of the price paid by a buyer. For example, two copies of the shadow bid may be included in a set with received unadjusted bids that are collectively evaluated to determine whether and to which buyer the content inventory unit will be allocated and how much that buyer will pay. Thus, the second highest value in this set will be guaranteed to be at least as great as the shadow bid. If the shadow bid is the highest price in the set, then the content inventory unit may not be allocated to a bidder. In some implementations, the minimum sharing fraction may correspond to a minimum cost associated with operating the auction platform. The lowest sharing fraction may be determined based in part on this minimum cost associated with the auction platform. For example, the shadow bid may be determined 306 by the allocation module 130 of the content inventory auction platform 116 or the content inventory unit allocation module 270 of the auction platform 220.

One or more auction announcement messages may be transmitted 308 to potential buyers (e.g., advertiser 231 or demand side platform 241) to solicit bids. The auctions announcement message(s) may include information (e.g., content slot parameters or information about a user that requested the content) about the content inventory unit being auctioned and/or parameter of the auction. In some implementations, the auction announcement message(s) may include a minimum bid requirement for the auction. For example, the minimum bid requirement specified in an auction announcement message sent to a potential buyer may be equal to the reserve price divided by one minus a sharing fraction for bids from the potential buyer. In some implementations, the auction announcement message includes an indication of the shadow bid. For example, the auction announcement message(s) may be transmitted 308 through a network interface of content inventory auction platform 116 or auction platform 220.

Two or more bids for the content inventory unit may be received 310 from prospective buyers (e.g., advertiser 231 or demand side platform 241). The bids may be subject to different sharing fractions (e.g., maximum commissions charged by the auction platform). For example, a first bid may be subject to commission charges of up to 20% of the first bid that will be retained by an operator of an auction platform while a second bid may be subject to commission charges of up to 10% of the second bid. In some implementations, prospective buyers submit bids in response to an auction announcement message from the auction platform 220. For example, the bids may be received 310 through a network interface of content inventory auction platform 116 or auction platform 220.

The maximum bid may be identified 312 from among a set of bids including received unadjusted bids. In some implementations, the set of received bids considered includes only bids that have been verified as valid bids (e.g., by checking bidder information against a block list, checking the bid against a minimum bid requirement, and/or checking other characteristics of the bid against auction parameters specified by the seller). In some implementations, the set of bids considered may be augmented to include on or more copies (e.g., two copies) of the shadow bid.

If the maximum bid is a valid received bid 314, then the maximum bid is a winning bid and the content inventory unit is allocated 316 to the buyer that submitted the winning bid. A content item (e.g., an advertisement) from the buyer (e.g., advertiser 231) or a subsequent purchaser will be served as the content inventory unit and, in exchange, the buyer will pay a price that may depend on the received bids and/or the shadow bid. In some implementations, the content inventory unit is allocated to a buyer based on the results of a truthful auction. Data reflecting the allocation of the content inventory unit to the buyer and the price may be generated and stored in a data storage device. For example, the content inventory unit may be allocated 316 to a buyer by the allocation module 130 of the content inventory auction platform 116 or the content inventory unit allocation module 270 of the auction platform 220.

A payment from the buyer may be determined 318 based on the received bid(s) and/or the shadow bid according to the rules of an auction mechanism (e.g., a second price auction mechanism). In some implementations, a payment from the buyer is determined 318 as a maximum member of a set of prices that includes at least one of the two or more received bids. In some implementations, the set of prices used to determine the payment from the buyer also includes one or more copies of the shadow bid. For example, using a second-price auction mechanism, an auction price may be determined as a maximum of a set including two copies of the shadow bid and the two or more received bids with the exception of a highest of the two or more bids (e.g., excluding the winning bid). Consider an example where a reserve price of $0.50 has been specified, an auction platform has a minimum sharing fraction of 8%, and two bids are received for $1.00 and $0.90 respectively. The shadow bid may be determined as be $0.50/(1−0.08)=$0.5. After excluding the highest received bid of $1.00 and including the shadow bid, the buyer's payment may then be determined as max {$0.90, $0.54}=$0.90. For example, an auction price may be determined 318 by the allocation module 130 of the content inventory auction platform 116 or the content inventory unit allocation module 270 of the auction platform 220.

One or more adjusted bids may be determined 320 based on received bids and one or more sharing fractions that are associated respectively with the received bids. In some implementations, the adjusted bids are determined 320 by discounting the received bid(s) by a factor that is based on an applicable sharing fraction that each bid is subject to. For example, the adjusted bid(s) may be calculated according to:

b′ₙ=bₙ *(1−λₙ)

where b′ₙ is the adjusted bid for the nth potential buyer, bₙ is the received bid for the nth potential buyer, and λₙ is a sharing fraction that applies to the received bid for the nth potential buyer. For example, the adjusted bid(s) may be determined 320 by the allocation module 130 of the content inventory auction platform 116 or the content inventory unit allocation module 270 of the auction platform 220.

In some implementations (not shown in FIG. 3, but described above in relation to FIG. 1), the adjusted bid(s) may compared to the reserve price for the content inventory to check if the corresponding bid is a valid bid that will satisfy the auction parameters. For any adjusted bid that is less than the reserve price, a corresponding bid (e.g., the received bid upon which the adjusted bid is based) may be excluded from the set of prices that is considered to allocate the content inventory item and determine the buyer's price.

The payment to the seller (e.g., the publisher) that will result from the allocation may be determined 322. The payment to the seller may be determined 322 based on a second set of prices that includes at least one of the adjusted bid(s). In some implementations, the payment to the seller is determined 322 as a maximum member of a second set of prices that includes at least one of the adjusted bids. For example, the second set of prices may include all of the adjusted bids except for the highest adjusted bid. In some implementations, the second set of prices also includes the reserve price. Consider an example where a reserve price of $0.50 has been specified, a first bid of $1.00 subject to a 20% sharing fraction has been received, a second bid of $0.90 subject to a 10% sharing fraction has been received. The first adjusted bid may be determined as $1.00*(1−0.2)=$0.80. The first adjusted bid may be determined as $0.90*(1−0.1)=$0.81. After excluding the highest adjusted bid of $0.81 and including the reserve price, the payment to the seller may then be determined as max {$0.80, $0.50}=$0.80. The amount of revenue retained by the operator of the auction platform may also be determined. For example, the operator of the auction platform may receive the difference between the payment from the buyer and the payment to the seller as revenue. For example, the payment to the seller may be determined 322 by the allocation module 130 of the content inventory auction platform 116 or the content inventory unit allocation module 270 of the auction platform 220.

Data reflecting the allocation of the content inventory unit to the buyer may be transmitted 324. For example the data reflecting the allocation may be transmitted to the buyer (e.g., advertiser 231), the publisher (e.g., publisher 210), and/or a user device (e.g., user device 106 running a web browser). The data reflecting the allocation may include information identifying the buyer and the content inventory unit associated with the winning bid. In some implementations, the data reflecting the allocation may also include the price paid by the buyer, the revenue received by the seller, characteristics of the content inventory unit, and/or a content item that will be presented in the content inventory unit as a result of the allocation. In some implementations, information reflecting a content item supplied by the buyer is transmitted to a user device. In some implementations, the content item may be transmitted to the publisher who then relays the content to a user device. In some implementations, the publisher may only receive and relay a pointer to the content item, such as an address for the content item stored on a remote server run by the advertiser or another entity. In some implementations, an external device storing the content item may independently establish a communication with the user's access device based upon information supplied by the publisher with the description of the content inventory unit. Data reflecting the allocation of the content inventory unit may be transmitted in one or more messages over a network (e.g., network 102). For example, data reflecting the identification of the content inventory unit and the price to be paid by the buyer may be transmitted in a first message to the buyer, while data reflecting the revenues paid to the seller may be transmitted to the seller. For example, data reflecting the allocation of the content inventory unit to the buyer may be transmitted 324 through a network interface of content inventory auction platform 116 or auction platform 220.

If the maximum bid is not a valid received bid 314 (e.g., the maximum bid is a shadow bid), then the content inventory unit is not allocated to a buyer. Equivalently, the content inventory unit is allocated back to the seller (e.g., publisher 210). This result may be reflected in data transmitted 324 by auction platform through a network interface to inform the seller and/or any potential buyers that submitted bids.

FIG. 4 is block diagram of an example computer system 400 that can be used to allocate content inventory units. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, or some other large capacity storage device.

The input/output device 440 provides input/output operations for the system 400. In one implementation, the input/output device 440 can include one or more of a network interface devices, e.g., an Ethernet card, a serial communication device, e.g., an RS-232 port, and/or a wireless interface device, e.g., and 802.11 card. In another implementation, the input/output device can include driver devices configured to receive input data and send output data to other input/output devices, e.g., keyboard, printer and display devices 460.

The web server, advertisement server, and content inventory unit allocation module can be realized by instructions that upon execution cause one or more processing devices to carry out the processes and functions described above. Such instructions can include, for example, interpreted instructions, such as script instructions, e.g., JavaScript or ECMAScript instructions, or executable code, or other instructions stored in a computer readable medium. The web server and advertisement server can be distributively implemented over a network, such as a server farm, or can be implemented in a single computer device.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible program carrier, for example a computer-readable medium, for execution by, or to control the operation of, a processing system. The computer readable medium can be a machine readable storage device, a machine readable storage substrate, a memory device, or a combination of one or more of them.

The term “processing system” encompasses all apparatus, devices, and machines for processing data, including by way of example a programmable processor, a computer, or multiple processors or computers. The processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

Implementations of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client server relationship to each other.

While this specification contains many specific implementation details, these should not be construed as limitations on the scope of any claims or of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims.

What is claimed is:

1. A method performed by one or more data processing apparatus, the method comprising:
receiving a request for allocation of a content inventory unit;
receiving, at a content inventory auction platform, two or more bids for the content inventory unit, each bid being subject to a respective sharing fraction;
prior to adjustment of each bid based on the respective sharing fraction:
allocating the content inventory unit to a buyer that submitted a highest unadjusted bid from among the two or more bids; and
determining a first payment from the buyer as a maximum member of a first set of prices that comprises at least one of the two or more bids;
determining, after allocating the content inventory to the buyer that submitted the highest bid, one or more adjusted bids, where each adjusted bid is determined based on one of the two or more bids and the respective sharing fraction for the bid;
determining a second payment, less than the first payment from the buyer, to a seller as a maximum member of a second set of prices that comprises at least one of the adjusted bids;
determining a payment to an operator of the content inventory auction platform as a difference between the first payment from the buyer and the second payment to the seller;
transmitting data reflecting the allocation of the content inventory unit to the buyer; and
updating a user interface of a client device to present content from the buyer in the allocated content inventory unit.

2. The method of claim 1, wherein the second set of prices comprises a first price, and the method further comprises:
receiving the first price for the content inventory unit, where the first price is a minimum payment that the seller will accept for allocation of the content inventory unit.

3. The method of claim 2, further comprising:
transmitting an auction announcement message to a potential buyer, the auction announcement message comprising a minimum bid requirement for the auction; and
determining the minimum bid requirement to be equal to the first price divided by one minus a sharing fraction for bids from the potential buyer.

4. The method of claim 2, further comprising:
comparing each adjusted bid determined based on one of the two or more bids from the first set of prices to the first price; and
for any adjusted bid determined based on a particular bid from the first set of prices less than the first price, excluding the bid from the first set of prices.

5. The method of claim 1, wherein the first set of prices comprises a shadow bid and the method further comprises:
receiving a first price for the content inventory unit, where the first price is a minimum payment that the seller will accept for allocation of the content inventory unit; and
determining the shadow bid based on the first price, where the shadow bid is set equal to the first price divided by one minus a minimum sharing fraction for an auction platform.

6. The method of claim 1, wherein the first set of prices comprises all of the two or more bids except the highest bid from among the two or more bids.

7. The method of claim 1, wherein the second set of prices comprises all of the adjusted bids except a highest adjusted bid from among the adjusted bids.

8. The method of claim 1, wherein determining each adjusted bid comprises multiplying one of the two or more bids by one minus the respective sharing fraction for the bid.

9. The method of claim 1, wherein the content inventory unit is allocated to the buyer based on the results of a truthful auction.

10. One or more machine-readable storage devices storing instructions that are executable by one or more processing devices to perform operations comprising:
receiving a request for allocation of a content inventory unit;
receiving, at a content inventory auction platform, two or more bids for the content inventory unit, each bid being subject to a respective sharing fraction;
prior to adjustment of each bid based on the respective sharing fraction:
allocating the content inventory unit to a buyer that submitted a highest unadjusted bid from among the two or more bids; and
determining a first payment from the buyer as a maximum member of a first set of prices that comprises at least one of the two or more bids;
determining, after allocating the content inventory to the buyer that submitted the highest bid, one or more adjusted bids, where each adjusted bid is determined based on one of the two or more bids and the respective sharing fraction for the bid;
determining a second payment, less than the first payment from the buyer, to a seller as a maximum member of a second set of prices that comprises at least one of the adjusted bids; and
transmitting data reflecting the allocation of the content inventory unit to the buyer.

11. A system comprising:
memory storing instructions that are executable; and
one or more processing devices to execute the instructions to implement a content inventory auction platform, the content inventory auction platform for performing operations comprising:
receiving a request for allocation of a content inventory unit;
receiving, at a content inventory auction platform, two or more bids for the content inventory unit, each bid being subject to a respective sharing fraction;
prior to adjustment of each bid based on the respective sharing fraction:
allocating the content inventory unit to a buyer that submitted a highest unadjusted bid from among the two or more bids; and
determining a first payment from the buyer as a maximum member of a first set of prices that comprises at least one of the two or more bids;
determining, after allocating the content inventory to the buyer that submitted the highest bid, one or more adjusted bids, where each adjusted bid is determined based on one of the two or more bids and the respective sharing fraction for the bid;
determining a second payment, less than the first payment from the buyer, to a seller as a maximum member of a second set of prices that comprises at least one of the adjusted bids;
determining a payment to an operator of the content inventory auction platform as a difference between the first payment from the buyer and the second payment to the seller;
transmitting data reflecting the allocation of the content inventory unit to the buyer.
